(19) United States
(12) Patent Application Publication
(10) Pub. No.: US 2026/0218059 A1
(43) Pub. Date: Jul. 30, 2026

(54) PLASTIC RECYCLING PROCESS

(71) Applicant: BOREALIS AG, Vienna (AT)

(72) Inventors: Alberto MARTINEZ JOARISTI, Linz (AT); Ana Lilia MOTA SALINAS, Linz (AT); Elisa VASKIKARI, Porvoo (FI)

(21) Appl. No.: 19/141,426

(22) PCT Filed: Dec. 22, 2023
(86) PCT No.: PCT/EP2023/087752

§ 371 Date: Jun. 20, 2025

(30) Foreign Application Priority Data
Dec. 23, 2022 (EP) 22216507.8

(51) Int. Cl. C10G 1/02; B01J 6/00; B01J 8/04; C10G 49/00; C10G 69/06

(52) U.S. Cl. CPC C10G 1/02; B01J 6/008; B01J 8/0492; C10G 49/002; C10G 69/06; C10G 2300/1003

(57) ABSTRACT

A process for the treatment of a mixed plastic waste comprising: (I) pyrolyzing a mixed plastic waste in a pyrolysis reactor at a temperature of 250 to 700° C. and a pressure of 1.0 to 100 bar to form a pyoil; (II) directly transferring the pyoil to a hydrotreatment unit, optionally via a filter, and subjecting said pyoil to hydrotreatment with a catalyst in the presence of hydrogen at a temperature of 250 to 700° C. and a pressure of 1.0 to 100 bar to form a hydrotreated pyoil; (III) recycling a portion of the hydrotreated pyoil directly from the hydrotreatment unit to the pyrolysis reactor.

### BACKGROUND

This invention relates to the recycling of mixed plastic waste. In particular, the invention relates to a process and apparatus for recycling mixed plastic waste that allows direct transfer from a pyrolysis reactor used to depolymerise the waste to the hydrotreatment unit that is used to hydrogenate the pyrolysis oil formed in the pyrolysis reactor. Importantly, the invention also uses a recycle or recirculation direct from the hydrotreatment unit to pyrolysis reactor to enable the direct transfer process.

As concerns over the environment continue to grow, the recycling of plastic waste is an important consideration for all plastic producers. The chemical recycling of plastic typically requires depolymerisation, generally but not exclusively by pyrolysis of mixed plastic waste (MPW) to produce pyrolyis oil (called pyoil herein).

Generally, the raw pyoil is not fed directly to steam crackers to produce monomers suitable for the production of plastics as crackers utilise saturated hydrocarbons as feedstock and a pyoil will contain many unsaturated or aromatic components. The pyoil is therefore typically pretreated due to the high concentration of unsaturated components and impurities therein. This further treatment typically occurs in a hydrotreatment unit (HDT) followed by separation of the components that are formed based on their boiling points, i.e. fractionation. Certain fractions may then be sent for steam cracking.

The configuration of a system that can convert an MPW to the target hydrocarbon fractions can vary greatly, mainly depending on the quality of the MPW that is used. The MPW can vary based on the polyolefin content therein, its oxygen content, contaminant content and so on. Also some MPWs can be used to target specific end products such as LPG-Naphtha to “heavies”.

The pyrolysis of the MPW is typically carried out at low pressure and high temperature as this increases the yield of lower boiling points components which are typically removed before hydrotreatment. Pyoil is the product from the pyrolysis reactor and is mostly condensed into the liquid state. As such, pyoil is a mixture of many components with a boiling range between 0 and 600° C., especially 50 and 500° C.

The hydrotreatment reaction needed to saturate components of the pyoil and remove contaminants typically requires pressures above 20 bar and temperatures in the range of 350-450° C., to increase the activity of hydrogen.

Chemical recycling processes using pyoil typically cool and depressurise the pyoil before it is sent to the hydrotreatment unit, either because it is desired to separate lights before the hydrotreatment unit or because of the pressure difference between the pyrolysis reaction and the pressure required for the hydrotreatment unit is high. It is challenging to increase the pressure of the pyoil from the pyrolysis reactor to the hydrotreatment unit when the pyoil is partially in gaseous form. The pyoil is therefore cooled, gaseous lights can be removed and the pressure and temperature increased in the liquid state to the operating pressure and temperature of the hydrotreatment unit.

As a result, pumps to increase the pressure of the liquid pyoil, heat exchangers and a furnace need to be installed to heat up the pyoil up for the hydrotreatment unit.

After the mixed plastic waste is pyrolyzed therefore it is normal to separate the pyoil to recover at least the lights (low boiling point) fraction. For that reason, pyrolysis is typically effected at low pressures to facilitate the extraction of lights from the pyrolysis reactor. If the pressure in the pyrolysis reactor was high then these lights are more likely to be in the form of a liquid.

Typically therefore the lights are separated to leave a liquid hydrocarbon stream that needs hydrotreatment, i.e. hydrogenation to create saturates that can be cracked. The lights are removed and the resulting liquid hydrocarbon stream is then reheated and the pressure increased for entry into the hydrotreatment unit. Within the hydrotreatment unit, recycles are needed in order to control the exothermicity from the hydrogenation reactions.

Various MPW recycling processes are known. U.S. Pat. No. 4,642,401 describes a process for the production of hydrocarbons from pulverised plastic waste at high temperature and pressure in the presence of a solvent. Some hydrocarbons dissolve in the solvent to create a solvent phase and a residue phase. Dissolved hydrocarbons are recovered from the solvent phase once this is separated from the residue phase by lowering the temperature and pressure of that phase and subjecting it to distillation.

U.S. Pat. No. 10,851,309 describes a process for producing propylene and cumene. A plastic waste is converted to a hydrocarbon liquid stream and a pyrolysis gas stream in a pyrolysis unit. The hydrocarbon liquid stream is subjected to hydroprocessing in the presence of hydrogen in a hydroprocessing unit to yield a C5+ hydrocarbon product and a first gas stream. That hydrocarbon product is subject to a second separation to produce a C6 aromatics stream and C5+ hydrocarbons stream. A portion of saturated hydrocarbons isolated in the second separation is recycled to the pyrolysis unit or the HDT. There is no recycle therefore direct from the hydrotreatment reactor to pyrolysis reactor. The pressure in the pyrolysis unit is not discussed and the feed to the hydrotreatment reactor is liquid and not therefore the entire pyoil.

WO2018/069794 describes a process for producing olefins and aromatic hydrocarbons from mixed plastics. The mixed plastics are converted in a pyrolysis unit to a hydrocarbon product comprising a gas phase and a liquid phase. These streams are separated and the liquid stream is further separated into a first lower boiling point fraction and a second higher boiling point fraction. The second fraction is recycled to the pyrolysis unit and the first fraction is sent to a liquid steam cracker optionally via an hydrotreatment reactor. In a further embodiment, after the mixed plastics are converted in a pyrolysis unit to a hydrocarbon product comprising a gas phase and a liquid phase, the liquid phase is hydrotreated and the resulting hydrotreated pyoil is separated into a light and heavy fraction. The heavy fraction can be recycled to the pyrolysis unit. There is no recycle therefore direct from the hydrotreatment reactor to pyrolysis reactor.

WO2003/89548 describes a process for preparing lubricating base oil by blending a Fischer Tropsch feed together with a waste polyolefin. The mixture is fed to a pyrolysis unit and afterwards fractionated. The middle fraction (350-565° C.), potentially mixed with the heavies, is treated in a hydrotreatment reactor followed by a isomerization dewaxing unit (IDW). The heavy fraction (>565° C.) can be sent to the hydrotreatment reactor or recirculated to the pyrolysis unit.

WO2021/149590 describes a process in which a plastics waste is degassed before pyrolysis in the presence of a crude oil fraction to reduce viscosity.

WO2022/146778 describes a method and system for a desulfurization process for the fuel produced from waste tyres. The method requires pyrolyzing waste tyres to produce the corresponding pyrolysis oil (i.e. pyoil) which is then hydrotreated to allow desulfurization and then finally distilled to obtain corresponding fuel products, such as kerosene, naphtha, fuel and diesel. There is no teaching of the direct recycling of the hydroprocessed product to the pyrolyser and no teaching of directly transferring the pyoil to a hydrotreatment unit.

### SUMMARY OF INVENTION

The inventors have now found that pyoil can be transferred directly from the pyrolysis reactor to the hydrotreatment unit if there is a partial recycle or partial recirculation from the hydrotreatment unit to the pyrolysis reactor. The process in the pyrolysis reactor can be effected at high pressure and high temperature and the resulting pyoil can be directly transferred to the hydrotreatment unit without separation of any fluid component of the pyoil. It can be transferred to the hydrotreatment unit without substantial cooling or depressurisation of the pyoil to allow lights removal.

In this invention therefore, the MPW that is pyrolyzed within the pyrolysis reactor is diluted with at least the recirculated hydrotreated pyoil from the hydrotreatment unit. The feed therefore to the pyrolysis reactor includes MPW and recycled hydrotreated pyoil. Importantly, nothing needs to be removed from the recycle coming from the hydrotreatment unit before its entry to the pyrolysis reactor. The pyoil that results from the pyrolysis reactor is therefore is a mixture of pyoil produced from the MPW and the further pyrolysis of the recycle stream.

No one before has considered a process in which the MPW is directly transferred from the pyrolysis reactor to the hydrotreatment unit without separation of fluid components and ideally without any significant change in temperature or pressure between the pyrolysis reactor and hydrotreatment unit. The ability to reduce temperature or pressure changes offers a more energy efficient process.

Without wishing to be limited by theory, it is envisaged that the use of a recycle stream direct from the hydrotreatment unit to the pyrolysis reactor allows the direct transfer of the pyoil from the pyrolysis reactor to the hydrotreatment unit because the hydrogenated fraction, which can be cracked again in the pyrolysis reactor, also serves as a solvent or medium to dissolve the pyoil at high pressures.

Viewed from one aspect the invention provides a process for the treatment of a mixed plastic waste comprising:
(I) pyrolyzing a mixed plastic waste in a pyrolysis reactor at a temperature of 250 to 700° C. and a pressure of 1.0 to 100 bar to form a pyoil;
(II) directly transferring the pyoil to a hydrotreatment unit, optionally via a filter, and subjecting said pyoil to hydrotreatment in the presence of hydrogen at a temperature of 250 to 700° C. and a pressure of at least 1.0 to 100 bar to form a hydrotreated pyoil;
(III) recycling a portion of the hydrotreated pyoil directly from the hydrotreatment unit to the pyrolysis reactor.

Viewed from another aspect the invention provides a process for the treatment of a mixed plastic waste comprising:
(I) suppling a pyrolysis reactor with a feed comprising a mixed plastic waste;
(II) pyrolyzing said feed comprising the mixed plastic waste in the pyrolysis reactor at a temperature of 250 to 700° C. and a pressure of 1.0 to 100 bar to form a pyoil;
(III) directly transferring the pyoil to a hydrotreatment unit, optionally via a filter, and subjecting said pyoil to hydrotreatment with a catalyst in the presence of hydrogen at a temperature of 250 to 700° C. and a pressure of 1.0 to 100 bar to form a hydrotreated pyoil;
(IV) recycling a portion of the hydrotreated pyoil directly from the hydrotreatment unit to the pyrolysis reactor wherein the weight ratio of the hydrotreated pyoil recycled to the pyrolysis reactor to the mixed plastic waste fed to the pyrolysis reactor is from 10:1 to 1:1, preferably 3:1 to 5:1.

Viewed from another aspect the invention provides an apparatus for the treatment of a mixed plastic waste comprising:
(I) a pyrolysis reactor;
(II) a hydrotreatment unit;
(III) a recycle conduit directly connecting the hydrotreatment unit to the pyrolysis reactor;
wherein the pyrolysis reactor is directly connected to the hydrotreatment unit via a conduit, said conduit may optionally comprise a filter.

### DEFINITIONS

Mixed plastic waste is abbreviated MPW herein.

The pyrolysis reactor is a vessel in which the MPW and recycled hydrotreated pyoil is heated under pressure to generate a pyrolysis oil. There should not be any hydrogen feed to the pyrolysis reactor. The terms pyrolysis reactor and pyrolysis unit are used interchangeably herein.

The product formed in the pyrolysis reactor is a pyrolysis oil, called pyoil herein.

The hydrotreatment unit is a vessel or series of reactors in which a hydrogenation reaction occurs to saturate unsaturated components of the pyoil. The terms hydrotreatment reactor or reactors and hydrotreatment unit are used interchangeably herein.

Transfer from the pyrolysis reactor to the hydrotreatment unit occurs directly, optionally via a filter. This means therefore that no fluid part of the pyoil is removed before the transfer to the hydrotreatment unit.

The recycle from the hydrotreatment unit to the pyrolysis reactor occurs directly, optionally via a filter. This means therefore that no fluid part of the hydrotreated pyoil is removed before the recycle to the pyrolysis reactor.

It will be appreciated that conveying conduits (typically pipes) including direct conveying conduits from one unit to another within the apparatus of the invention may require pumps (if gravity cannot be used) and that any conduit that enables transfer may contain valves to prevent back flow. These are not discussed further herein.

The term heavies defines a liquid hydrocarbon comprising hydrocarbon compounds with a boiling point typically above 360° C., and with a number of carbon atoms above C20-C24.

The light fraction (lights) comprises hydrocarbon compounds with a boiling point typically below 200° C., and with a number of carbon atoms below C10-C12.

The medium fraction comprises hydrocarbon compounds with a boiling point typically between 200 and 360° C., and with a number of carbon atoms between C10 and C24.

The hydrotreated pyoil is recycled or recirculated from the hydrotreatment unit to the pyrolysis reactor. The terms recycle or recirculate are used interchangeably herein.

### BRIEF DESCRIPTION OF THE FIGURES

FIG. 1 shows an apparatus suitable for use in the treatment of mixed plastic waste according to the invention.

### DETAILED DESCRIPTION OF INVENTION

This invention relates to a process and apparatus for recycling mixed plastic waste. The mixed plastic waste can be derived from post-industrial or post-consumer plastic waste. Mixed plastic wastes can comprise chlorinated plastics such as chlorinated polyethylene, polyvinylchloride (PVC), or polyvinylidene chloride (PVDC),
non-chlorinated plastics such as polyolefins such as polyethylene, polypropylene, polyethylene terephthalate (PET), polybutylene terephthalate, and polystyrene.

In some aspects, the mixed plastics can comprise PVC, PVDC, polyethylene terephthalate, polybutylene terephthalate, polyolefins, polystyrenes and the like, or combinations thereof. Waste plastics as disclosed herein also include used tires.

It is preferred if the mixed plastic waste is primarily polyolefinic. It is preferred if the mixed plastic waste comprises more than 75 wt % polyolefinic components, especially at least 75 wt % polyethylene and polypropylene components.

Ideally the mixed plastic waste used herein should contain 10 wt % or less of chlorinated plastics. In one embodiment therefore the invention may utilise a sorting unit to separate out any plastics that are unsuitable for pyrolysis, e.g. chlorinated plastics.

It is appreciated however that even a MPW that is nominally free of chlorinated plastics might contain contaminants. It is therefore preferred if any MPW is subject to a dechlorination process before entering the pyrolysis unit. This step is designed to remove chlorine (e.g. in the form of HCl) and other heteroatoms from the hydrocarbons that are present in the MPW.

Dechlorination of plastic mixtures from domestic waste as well as from other chlorine containing mixtures such as electronic scrap is an important step in chemical recycling of polymers. To ensure that the pyrolysis procedure is safe, the nature of any combustion processes and the emissions from the pyrolysis unit etc must be known. Removing chlorine (and other heteroatoms) is preferred before a pyrolysis process occurs therefore as chlorine waste gases (and other heteroatom containing gases) are avoided.

Dechlorination of the MPW can be carried out in a dechlorination reactor which is a vessel adapted to allow moderate heating of the MPW and to allow chlorinated gases (and other heteroatom gases) that are formed to be removed. It is preferred if the dechlorination reactor is effected in the absence of hydrogen.

It may be that along with heteroatom containing impurities, some light gaseous hydrocarbons are formed during the dechlorination step. These can be removed with the heteroatom containing impurities and the gaseous products sent to a scrubber. Light hydrocarbons of value can then be separated and recovered from the scrubber using known processes.

The dechlorination of chlorinated plastics can be conducted at moderate temperatures prior to the thermal degradation of the polymer. Low temperature heating of the MPW can convert therefore chlorine in the MPW into into hydrogen chloride. Suitable temperatures are 150 to 350° C., preferably 250 to 300° C. Often the dechlorination step will be effected at lower temperature than the pyrolysis step such as <250° C. The temperature should be sufficient to decompose PVC producing HCl gas, without actually pyrolyzing the MPW.

Suitable pressures are 1-5 bars. This process can be comparatively short compared to the actual pyrolysis process. Typical hourly space velocity of the fresh melt fed from about 0.2 h⁻¹ to about 0.5h⁻¹, and under a nitrogen blanket or a dedicated nitrogen sweeping rate.

The dechlorination process (which is known in the art) can ensure that the chloride levels in the MPW fed to the pyrolysis reactor are less than about 10 parts per million weight (ppmw) chloride, alternatively less than about 5 ppmw chloride, or alternatively less than about 3 ppmw chloride, based on the total weight of the MPW.

After the MPW has been optionally dechlorinated, the MPW is passed to the pyrolysis reactor.

The feed to the pyrolysis unit comprises the MPW optionally sorted and dechlorinated as discussed above and the hydrotreated pyoil recycle direct from the hydrotreatment unit described further below. It is also possible that heavies separated from the hydrotreated pyoil after the hydrotreatment process can be returned to the pyrolysis reactor. Finally, it is possible that a pyoil from another source or a biooil may be fed to the pyrolysis reactor as an additional feed. The pyoil or biooil from another source may also be feed to the filter after the pyrolysis reactor to become part of hydrotreatment reaction.

It is preferred if MPW forms at least 75 wt % of the feed to the pyrolysis reactor.

### Pyrolysis

The pyrolysis reactor may be any suitable vessel configured to convert mixed waste plastic into gas phase and liquid phase products (e.g. simultaneously). The pyrolysis reactor may contain inert material (such as sand, alumina) or a pyrolysis catalyst, e.g. zeolite. It is however preferred if no catalyst is used and the process simply involves heat. The pyrolysis unit may be operated adiabatically, isothermally, nonadiabatically, non-isothermally, or combinations thereof.

The pyrolysis reaction is ideally carried out in a single pyrolysis reactor although in theory two pyrolysis reactors connected in series might be used. In that scenario the recycle stream from the hydrotreatment unit should occur to at least one, preferably both reactors. If the recycle occurs to one unit then it is preferably the first in the sequence.

One such reactor might use a catalyst (and hence generate a catalytically cracked pyoil) and one might use simply thermal treatment to generate a thermally cracked pyoil. Catalysts of interest in the process are known and any conventionally known catalyst can be used. Typical catalysts include zeolites.

The pyrolysis unit can be configured to pyrolyse (e.g. crack) components of the mixed plastics stream fed to the pyrolysis unit. Examples of reactions which may occur in the pyrolysis unit include isomerization, selective ring opening, cracking of long chain molecules or combinations thereof.

The pyrolysis reactor processes may occur at a temperature of 250° C. to 700° C., alternatively 275° C. to 700° C., or alternatively 300° C. to 400° C. More preferably however the temperature is at least 400° C. such as 400 to 700° C.

The pyrolysis reaction is performed at a range of 1.0 to 100 bar, such as 2 to 100 bar, such as 5 to 50 bar, preferably in the range of 10 to 100 bar, especially 20-50 bar or 10 to 25 bar.

The residence time within the pyrolysis reactor may be 10 to 180 min depending on the temperature, preferably 15 to 60 min.

Typically the pyrolysis process occurs at a higher temperature and for longer than any dechlorination process.

The pyrolysis reactor is preferably operated continuously and hence pyoil that forms is constantly removed from the pyrolysis reactor during operation.

In conventional pyrolysis processes, the pyoil that forms is separated into gas and liquid portions after the pyrolysis reactor. The pyoil is therefore typically fed to a separating unit that acts as a condenser. The gas stream may be removed and the liquid hydrocarbon stream that is formed may then be conveyed to the hydrotreatment unit. The liquid hydrocarbon stream would be reheated and pressurised up to the required conditions in the hydrotreatment unit. Whilst this process allows the isolation of a lights fraction, it is energy intensive. It would be useful if there was no requirement to cool and depressurise the pyoil after the pyrolysis reaction.

In the present case, the pyoil produced in the pyrolysis reactor is conveyed directly to the hydrotreatment unit without fluid separation. It may be that a filter is used to filter the pyoil before it enters the hydrotreatment unit but no separation of fluid components occurs. The filter simply removes any solid components that are present in the pyoil.

As the pyrolysis reaction is an endothermic process and the hydrogenation an exothermic process, this closed loop between both unit operations allows good temperature and heat control.

The pyoil at this point comprises a variety of components such paraffins, olefins, naphthenes, and aromatic compounds.

It is preferred if the pressure and temperature within the pyrolysis reactor is such that substantially all fluid (i.e. liquid and gaseous components) components of the pyoil are in the liquid phase at the end of the pyrolysis reaction. The required temperatures and pressures are preferably sustained in any conduit that links the pyrolysis and hydrotreatment unit such that there are no gaseous components in the conduit.

### Hydrotreatment Unit

In the hydrotreating unit, hydrogen is fed to saturate the compounds present and hence to form a hydrotreated pyoil. Preferably therefore, the only feed to the hydrotreatment unit is pyoil and hydrogen. The hydrotreating unit may be any vessel or series of vessels configured to contain the hydrotreating reaction. The hydrotreating unit may include one or more beds of a hydroprocessing catalyst. The hydrotreating unit may be operated adiabatically, isothermally, nonadiabatically, non-isothermally, or combinations thereof.

The hydrotreatment unit is preferably operated using a catalyst in the presence of hydrogen. Unsaturated compounds are therefore converted to saturated ones e.g. olefins, aromatic compounds, to paraffins, i-paraffins, naphthenes.

Additionally, reactions in the hydrotreatment unit may cause a rupture of a bond of an organic compound, resulting in “cracking” of a hydrocarbon molecule into two or more smaller hydrocarbon molecules.

The hydrotreatment catalyst may be any catalyst used for hydrogenation of olefins and aromatic hydrocarbons (e.g. a commercially available hydrotreating catalyst). The hydrotreatment catalyst can comprise a cobalt and molybdenum catalyst (Co—Mo catalyst) e.g. on an alumina support, a nickel and molybdenum catalyst (Ni—Mo catalyst) e.g. on an alumina support, a tungsten and molybdenum catalyst (W—Mo catalyst) e.g. on an alumina support, cobalt and molybdenum oxides e.g. e.g. on an alumina support, nickel and molybdenum oxides e.g. on an alumina support, tungsten and molybdenum oxides e.g. on an alumina support, cobalt and molybdenum sulphides e.g. on an alumina support, nickel and molybdenum sulphides e.g. on an alumina support, tungsten and molybdenum sulphides e.g. on an alumina support, a zeolite comprising one or more metals or combinations thereof.

Other catalysts suitable for use as the hydrotreatment catalyst may include platinum and palladium catalyst (Pt-Pd catalyst) e.g. on an alumina support, nickel sulphides suitable for slurry processing, molybdenum sulphides suitable for slurry processing, and the like, or combinations thereof. The zeolites can comprise ZSM-5, ZSM-11, Y, high-silica Y, USY, and the like, or combinations thereof. Each metal of the one or more metals of the zeolite can be independently selected from the group consisting of cobalt, molybdenum, tungsten, nickel, titanium, copper, magnesium, tin, iron, zinc, tungsten, vanadium, gallium, calcium, manganese, ruthenium and rhenium.

The hydrotreatment unit is preferably operated at a temperature of 250 to 700° C., such as 300 to 550° C., preferably 350 to 450° C., especially 400 to 450° C.

The hydrotreatment unit can operate at pressures of 1.0 to 100 bar, such as 20 to 100 bar, especially 20 to 50 bar.

The residence time within the hydrotreatment unit is 0.2 to 10 hours, preferably 5 to 10 hour.

The liquid hour space velocity may be 0.1 and 1h⁻¹; preferably between 0.1 and 0.2 h⁻¹

As previously, noted a key aspect of the present invention is that the pyoil can be transferred to the hydrotreatment unit without a separation step, i.e. without a separation of the fluid components into a gas component and a liquid component. Moreover, it is preferred if the temperature and pressure conditions with both pyrolysis unit and hydrotreatment unit are substantially similar. Ideally therefore, there is no need to cool/heat or pressurise/depressurise between these two steps and the process reduces energy consumption.

If the hydrotreatment unit comprises a series of hydrotreatment reactors in series then there must be a direct recycle from at least one of those reactors, such as the first or the last reactor in the series, typically the last. It is possible to have recycles from one or more than one hydrotreatment reactors. Alternatively, the recycle does not come from the last reactor in the series and the last reactor is only used to increase the quality of the fractions going further downstream in the process, e.g. to the steam cracker, since the fractions being recycled to the pyrolysis reactor do not need to be of the same quality. The benefit of this setup is that the size and investment of the hydrotreatment unit can be reduced, since there is no need to polish the fractions that are recycled back to pyrolysis.

It is preferred if the temperature within the pyrolysis reactor and the hydrotreatment unit are similar, i.e. within 300° C. of each other, preferably within 200° C. of each other, especially within 100° C. of each other. Typically, pyrolysis reactor temperature will be higher than hydrotreatment unit hydrogenation by 100-150° C.

It is preferred if the pressure within the pyrolysis reactor and the hydrotreatment unit is within 25 bars of each other, such as 20 bars of each other especially 10 bars of each other, most especially 5 bars of each other. Ideally the pressure conditions are the same in both pyrolysis reactor and hydrotreatment unit.

If there is a difference it is preferred if the pressure within the hydrotreatment unit is higher and the temperature in the pyrolysis reactor is higher.

The ability to transfer components directly from the pyrolysis reactor to the hydrotreatment unit is energy efficient as there is no requirement to cool down completely, e.g. below 250° C., depressurise, reheat and repressurise. The pyoil may already be at or near a temperature and pressure suitable for the hydrotreatment unit and hence the process of the invention reduces energy usage. Even if some changes in pressure and temperature are required between the pyrolysis reactor and the hydrotreatment reactor, the fact that these are reduced relative to conventional operation leads to a reduction in energy usage.

The hydrotreatment unit is preferably operated continuously.

A portion of the hydrotreated pyoil formed during the hydrotreatment step is recycled directly to the pyrolysis reactor. There is no need therefore to remove any components from the hydrotreated pyoil fluid before it is recycled.

The amount of hydrotreated pyoil recycled to the pyrolysis reactor can vary. Generally however, the pyrolysis reactor is fed with more recycle than MPW feed in weight terms. In one embodiment, the invention requires recycling a portion of the hydrotreated pyoil directly from the hydrotreatment unit to the pyrolysis reactor wherein the weight ratio of the hydrotreated pyoil recycled to the pyrolysis reactor to the mixed plastic waste fed to the pyrolysis reactor is from 10:1 to 1:1, preferably 3:1 to 5:1.

Thus, if there is 1000 kg/h of recycled hydrotreated pyoil fed to the pyrolysis reactor then the amount MPW fed to the pyrolysis reactor may be from 100 to 1000 kg,/h preferably 300 to 500 kg/h.

It can be envisaged that the recycle hydrotreated pyoil acts as a kind of solvent in the pyrolysis unit.

The hydrotreated pyoil that is not recycled can be removed from the hydrotreatment unit and fractionated as is known. The hydrotreated pyoil may therefore be removed and transferred to a separation unit. The hydrotreated pyoil may be subjected to a steam stripping reaction to remove any water soluble impurities and the resulting sour water removed.

The hydrotreated pyoil can therefore be cooled and depressurised to form a lights fraction, medium fraction and heavies. The hydrotreated pyoil may also contain some unreacted hydrogen which can be separated and recycled to the hydrotreatment unit.

The light fraction typically comprises hydrocarbon compounds with a boiling point below 200° C. The medium fraction typically comprises hydrocarbon compounds with a boiling point in the range 200 to 360° C. The heavy fraction typically comprises hydrocarbon compounds with a boiling point above 360° C.

Alternatively, a light fraction may contain hydrocarbons such as mainly C4 to C12; a medium fraction may contain hydrocarbons such as mainly C10 to C24 and a heavy fraction may contain hydrocarbons such as mainly C20 and above.

The hydrotreated pyoil can be separated into fractions such as three fractions based on the boiling point of the fractions as above. Ideally, a lights fractions is collected overhead and a heavies fraction removed from the base.

Whilst any fraction of the hydrotreated pyoil may be sent to a steam cracker for further cracking, ideally it is the medium fraction that is steam cracked.

The components present in the hydrotreated pyoil are typically saturated at this point and can be readily cracked. In the steam cracker, saturated hydrocarbons are broken down into smaller, often unsaturated, hydrocarbons. It is the principal industrial method for producing the lighter alkenes, including ethylene and propylene and is conventional.

The steam cracker uses steam in steam cracking furnaces to produce lighter hydrocarbons. Typically, the reaction temperature is very high, at around 850° C. Any hydrogen that is emitted can be used in the hydrogenation reaction in the hydrotreatment unit. The steam cracker can be operated as is well known in the art.

The heavies fraction obtained in the hydrotreatment unit (may be recycled back to the pyrolysis unit.

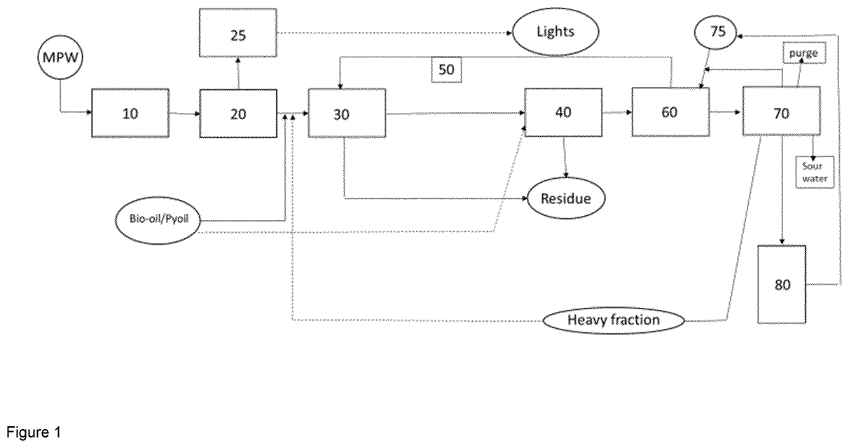

The invention further relates to an apparatus suitable for carrying out the process of the invention. The apparatus will be further defined in relation to FIG. 1 below.

FIG. 1 shows an apparatus suitable for use in the treatment of mixed plastic waste according to the invention.

Mixed plastic waste can be fed to the pyrolysis unit 30 via a sorting unit 10 and a dechlorination unit 20. Any material removed during the dechlorination step can be sent for scrubbing in the scrubber 25 from where lights can be isolated.

Biooil or pyoil from another source can also be fed into the pyrolysis unit. There is also the option that a heavy fraction recovered downstream after the separation of the hydrotreated pyoil may be recycled to the pyrolysis unit.

The pyoil formed in the pyrolysis unit can be filtered in a filter 40 to remove any solid components and the residue recovered. The pyoil may then be directly transferred to hydrotreatment unit 60 without any separation of the fluid components (i.e. the gas and liquid components) of the pyoil. Hydrogen is fed to the hydrotreatment unit 60 from hydrogen store 75 via a compressor 76 (not shown).

The hydrotreated pyoil formed in the hydrotreatment unit can be transferred to a separation unit 70 where heavies can be separated and any lights purged. Water may be used in the separation process to remove any water soluble impurities and hence sour water formed.

The residual fluid hydrotreated pyoil can be sent for cracking in a steam cracking (80) process.

Importantly, there is a recycle stream 50 directly from the hydrotreatment unit 60 to pyrolysis reactor 30.

The apparatus of the invention therefore contains as essential features:
(I) a pyrolysis reactor;
(II) a hydrotreatment unit;
(III) a recycle conduit directly connecting the hydrotreatment unit to the pyrolysis reactor;
wherein the pyrolysis reactor is directly connected to the hydrotreatment unit via a conduit, said conduit may optionally comprise a filter.

Preferably the apparatus comprises
(IV) a dechlorination unit in fluid connection with the pyrolysis reactor;
(V) a separation unit in fluid connection with the hydrotreatment unit;
(VI) a steam cracker in fluid connection with said separation unit;
(VII) a recycle conduit connecting the separation unit and pyrolysis reactor.

### REFERENCE NUMERAL LIST

10 Sorting Unit
20 Dechlorination unit
25 Scrubber
30 Pyrolysis unit
40 Filter
50 Recycle
60 Hydrotreatment unit
70 Separation unit
75 Hydrogen store via a compressor 76 (not shown).
80 Steam cracker

1. A process for the treatment of a mixed plastic waste comprising:
(I) pyrolyzing a mixed plastic waste in a pyrolysis reactor at a temperature of 250 to 700° C. and a pressure of 1.0 to 100 bar to form a pyoil;
(II) directly transferring the pyoil to a hydrotreatment unit, optionally via a filter, and subjecting said pyoil to hydrotreatment with a catalyst in the presence of hydrogen at a temperature of 250 to 700° C. and a pressure of 1.0 to 100 bar to form a hydrotreated pyoil;
(III) recycling a portion of the hydrotreated pyoil directly from the hydrotreatment unit to the pyrolysis reactor.

2. A process for the treatment of a mixed plastic waste comprising:
(I) suppling a pyrolysis reactor with a feed comprising a mixed plastic waste;
(II) pyrolyzing said feed comprising the mixed plastic waste in the pyrolysis reactor at a temperature of 250 to 700° C. and a pressure of 1.0 to 100 bar to form a pyoil;
(III) directly transferring the pyoil to a hydrotreatment unit, optionally via a filter, and subjecting said pyoil to hydrotreatment with a catalyst in the presence of hydrogen at a temperature of 250 to 700° C. and a pressure of 1.0 to 100 bar to form a hydrotreated pyoil;
(IV) recycling a portion of the hydrotreated pyoil directly from the hydrotreatment unit to the pyrolysis reactor wherein the weight ratio of the hydrotreated pyoil recycled to the pyrolysis reactor to the mixed plastic waste fed to the pyrolysis reactor is from 10:1 to 1:1, preferably 3:1 to 5:1.

3. A process as claimed in claim 1 wherein the pyrolysis step (I) is carried out at a pressure of 2 to 100 bar, preferably 5 to 50 bar, more preferably 10 to 25 bar.

4. A process as claimed in claim 1 wherein the pyrolysis step (I) is carried out at a temperature of at least 400° C.

5. A process as claimed in claim 1 wherein the hydrotreatment step (II) is carried out at a temperature of at least 300 to 550° C., preferably 350 to 450° C., especially 400 to 450° C.

6. A process as claimed in claim 1 wherein the hydrotreatment step (II) is carried out at a pressure of 20 to 50 bar.

7. A process as claimed in claim 1 where in the mixed plastic waste is subjected to dechlorination before entering the pyrolysis reactor.

8. A process as claimed in claim 1 wherein all fluid components within the pyrolysis reactor are transferred to the hydrotreatment unit.

9. A process as claimed in claim 1 wherein there is no separation of gas and liquid components present in the pyoil between the pyrolysis reactor and hydrotreatment unit.

10. A process as claimed in claim 1 wherein the pyrolysis reactor operates continuously.

11. A process as claimed in claim 1 where in the pyoil is filtered between the pyrolysis reactor and the hydrotreatment unit or wherein a solid component which is formed during the pyrolysis step (I) is removed from the pyrolysis reactor and is not sent to the hydrotreatment unit.

12. A process as claimed in claim 1 wherein a portion the hydrotreated pyoil is removed from the hydrotreatment unit and subjected to separation into fractions based on the boiling point of the hydrotreated pyoil in a separation unit.

13. A process as claimed in claim 11 wherein the highest boiling point fraction (the heavies fraction) is separated and at least partially recycled to the pyrolysis reactor.

14. A process as claimed in claim 11 wherein a liquid non-heavies fraction is separated and is subjected to steam cracking.

15. A process as claimed in claim 1 wherein hydrogen is recycled from the separation unit to the hydrotreatment unit.

16. A process as claimed in claim 1 wherein the only feed to the hydrotreatment unit is pyoil and hydrogen.

17. An apparatus for the treatment of a mixed plastic waste comprising:
(I) a pyrolysis reactor;
(II) a hydrotreatment unit;
(III) a recycle conduit directly connecting the hydrotreatment unit to the pyrolysis reactor;
wherein the pyrolysis reactor is directly connected to the hydrotreatment unit via a conduit, said conduit may optionally comprise a filter.

18. An apparatus as claimed in claim 17 further comprising:
(IV) a dechlorination unit in fluid connection, such as direct fluid connection, with the pyrolysis reactor;
(V) a separation unit in fluid connection with the hydrotreatment unit
(VI) a steam cracker in fluid connection with said separation unit
(VII) a recycle conduit connecting the separation unit and pyrolysis reactor.
